(19) United States
(12) Patent Application Publication
(10) Pub. No.: US 2015/0354611 A1
(43) Pub. Date: Dec. 10, 2015

(54) PUSH-PUSH LATCH WITH LOCKING OPTION AND MODIFIABLE OR FIXED JAW PROFILE

(71) Applicant: Nathaniel Johnathan Wasankari, Rio Rancho, NM (US)

(72) Inventor: Nathaniel Johnathan Wasankari, Rio Rancho, NM (US)

(21) Appl. No.: 14/298,928

(22) Filed: Jun. 8, 2014

(51) Int. Cl. F16B 2/18

(52) U.S. Cl. CPC F16B 2/18

(57) ABSTRACT

Disclosed is a push-push latch capable of retaining a multitude of objects with the option of locking the latch in one or more positions, providing one handed operation and controlling access. The improved push-push latch can contain opposing jaws with a unique profile for engaging objects as well as the inner slide housing may contain features for indexing the retained object. The push-push latch, can hold objects and allow the user to gain access faster than was hereto for possible, with improved security of objects preventing theft and death in the case of unsecured firearms.

### STATEMENT REGARDING FEDERALLY SPONSORED R&D

None.

### NAMES OF PARTIES TO A JOINT RESEARCH AGREEMENT

None.

### CROSS REFERENCE TO RELATED APPLICATIONS

None.

### BACKGROUND OF THE INVENTION

1. Field of the Invention

The present invention relates to a push-push latching mechanism in which could contain a locking feature preventing operation at the desired location. It is adaptable for engaging a variety of objects with a multitude of profiles. The latch can be used to secure objects such as firearms, tools, cables, tablets, computers and more. It is operated by pushing inward toward the latch to secure the object and then pushing inward toward the latch to release the object.

2. Description of the Prior Art

Firearms are stolen every day from the home of the owner. Furthermore these firearms are at times used by un-intended persons such as children or an intruder. Many gun owners do not own a locking safe nor do they properly maintain secure possession of their firearms while inside their home or vehicle. These weapons are staged for personal defense and located in the entry coat closet, master bedroom closet, behind the master bedroom door, beside the bed or any number places that are not secured from theft and miss use. Furthermore the security devices that are available require cumbersome two handed operation and multiple steps to rightfully gain possession of the firearm. The current inventions also do not offer universal adaptation to wide variety of weapons and multiple uses.

The same can be said for items that the owner wishes to secure such as computers, hand tools, power equipment, jewelry and many more items. These items are often too large to be stored in a locking cabinet as they are large in nature, require expensive locking cabinets and are often too cumbersome for daily or rapid use. Furthermore items that the owner wishes to display for public and friends to see are left unsecured hanging on a book, set on the floor, loaned against the wall or left on a counter.

U.S. Pat. No. 7,685,759 describes “An improved clamping device for a weapon accessory rail of a type having an elongate mounting structure of generally T-shaped cross-section.” This device does not allow the user to secure the clamp preventing un-controlled access. Furthermore this clamp device is limited to attachment to a weapon accessory rail limiting its ability to securely attach to additional items of less universal design and more varying shape.

U.S. Pat. No. 6,247,733 describes a push-push type latch mounted on corresponding moving and nonmoving components, such as a drawer or door and its frame. The latch may include a spring-biased fork for making an audible click to denote the latching and unlatching of the latch. This latch does not account for the engagement between the latch and the object being held. It merely describes an audible sound produced by a fork feature. This audible sound is naturally produced by almost every dicker and push-push type latch due to the design requirements for such operation. This does not solve the problem of adapting the push-push latch to specific and possible variable objects nor does it count for the option of locking the latch.

U.S. Pat. No. 6,669,250 describes a push-push latch that may include a body and a lever arm that is relatively coupled to the body, it demotes a torsion spring to move the pin engaged in a grove from the one stable position to another. This variation of the posh-push type latch does not solve nor mention the interaction between the latch and the item being latched. The internal mechanism does not contain the ability for the user to secure the latch in a position with the use of an external locking mechanism.

U.S. Pat. No. 8,701,331 describes an assembly for mounting on a standard mounting platform, such as a Picatinny-type rail. The assembly provides engaged contact between the rail and the surfaces of a base and a clamp. The clamp is rotatably attached to a base, allowing a user to quickly shift the assembly between a rail-engaging position and a disengaged position. The base also preferably contains a locking mechanism that allows a user to lock the assembly in a rail-engaging position. The assembly is particularly useful for the mounting of accessories, such as scopes and sights, onto Picatinny-type rails that are affixed to firearms.

This assembly does not allow for modification of the clamping profile for adaptation to multiple objects and weapons rail designs. Furthermore this assembly does not have engaging features that prevent the assembly from movement along the rail and instead miles on the clamping force to prevent movement. In addition this design does not allow for security control of the user preventing uncontrolled access, it merely “locks” into position meaning that it maintains the position the user left it in for a weapon accessory and does not address security of the weapon it self.

### SUMMARY OF THE INVENTION

The present invention is a push-push type latch which has the option of being locked in one or more positions and has opposing jaws which come together to retain an object. The latch is operated by applying a force toward the latch to engage the jaws and retain an object. A force is then pressed toward the latch to disengage the jaws and release the retained object. The latch has a capability of being locked to prevent the push action and either maintains retention of en object or preventing retention of an object. Also included is a set opposing jaws that have a mating shape for specific objects such as the so-called picatinny rail. Likewise the jaws shape may be altered by the user or manufacture to retain other specific objects. Furthermore the jaws may contain the ability to conform to objects, for example with the use of springs, or compressible material. The present invention includes an inner housing that moves relative to an outer housing generating an interaction between the outer housing and the jaws moving them in a manner that engages the retained object. The inner housing is held in one of two positions by the use of a heart shaped cam surface that guides an inner self-engaging latch mechanism.

It is therefore the primary objective of the present invention to provide a security locking capable push-push type latch.

It is another objective of the present invention to provide latching engagement to standard objects such as the so-called picatinny rail

It is another objective of the present invention to provide latching engagement to a variety objects in a multitude of shapes such as a tube or cable.

It is still a further objective of the present invention to provide indexing interaction between a push-push type latch and the object being latched.

It is still another object of the present invention to enhance the quality of retaining, securing and displaying objects with the use of a push-push type latch.

It is a further objective of the present invention to provide a push-push type latch that can be used for the addition of features to a firearm weapon such as scope, light, Taser, pepper spray, knife, grip, stock extension, bi-pod, tri-pod or additional firearm improving the function of the firearm and the user experience.

These and other objects of the present invention, will become apparent to those skilled in this art upon reading the accompanying description, drawings, and claims set forth herein. The headings provided herein are for the convenience of the reader only. No headings should fee construed to limiting upon the content in any way.

### BRIEF DESCRIPTION OF THE DRAWINGS

FIG. 1 shows the top view of the improved Push-Push latch With Locking Option and Modifiable or fixed Jaw Pro-file according to the concepts of the present invention.

FIG. 2 shows an isometric view of the improved Push-Push Latch With Locking Option and Modifiable or fixed Jaw Profile according to the concepts of the present invention.

FIG. 3 shows an isometric view of the improved Push-Push Latch With Locking Option and Modifiable or fixed Jaw Profile according to the concepts of the present invention.

FIG. 4 shows a front view of the improved Push-Push Latch With Locking Option and Modifiable or fixed Jaw Profile according to the concepts of the present invention.

FIG. 5 shows an exploded isometric view of the improved Push-Push Latch With Locking Option and Modifiable or fixed Jaw Profile according to the concepts of the present invention.

FIG. 8 shows an exploded top view of the improved Push-Push Latch With Locking Option and Modifiable or fixed jaw Profile according to the concepts of the present invention.

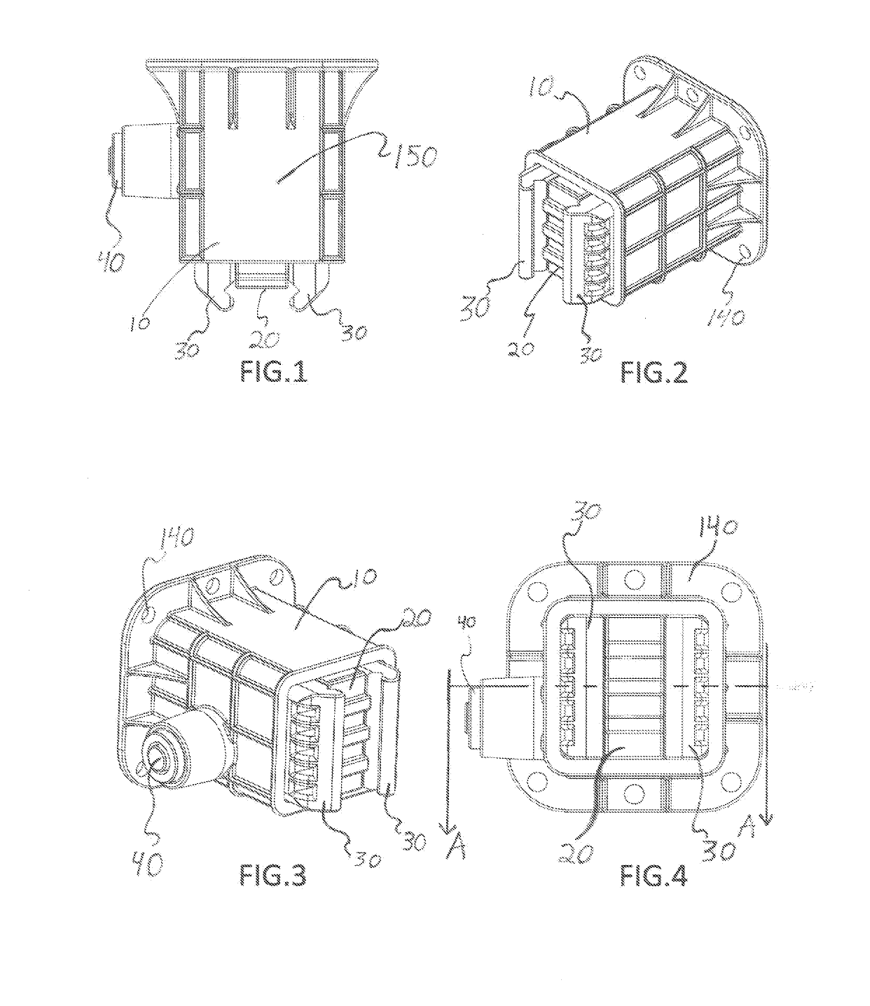

FIG. 7 shows a released latched position view taking a long line section line A-A of the improved Push-Push latch With Locking Option and Modifiable or fixed Jaw Profile according to the concepts of the present invention.

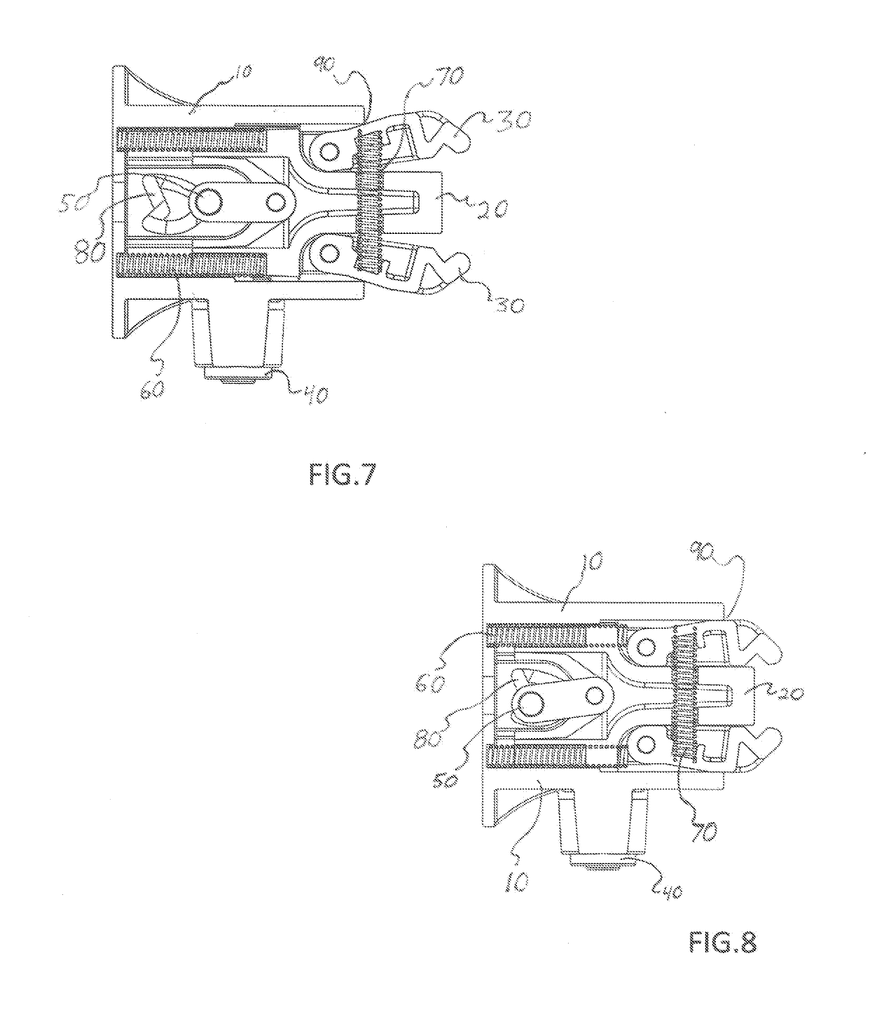

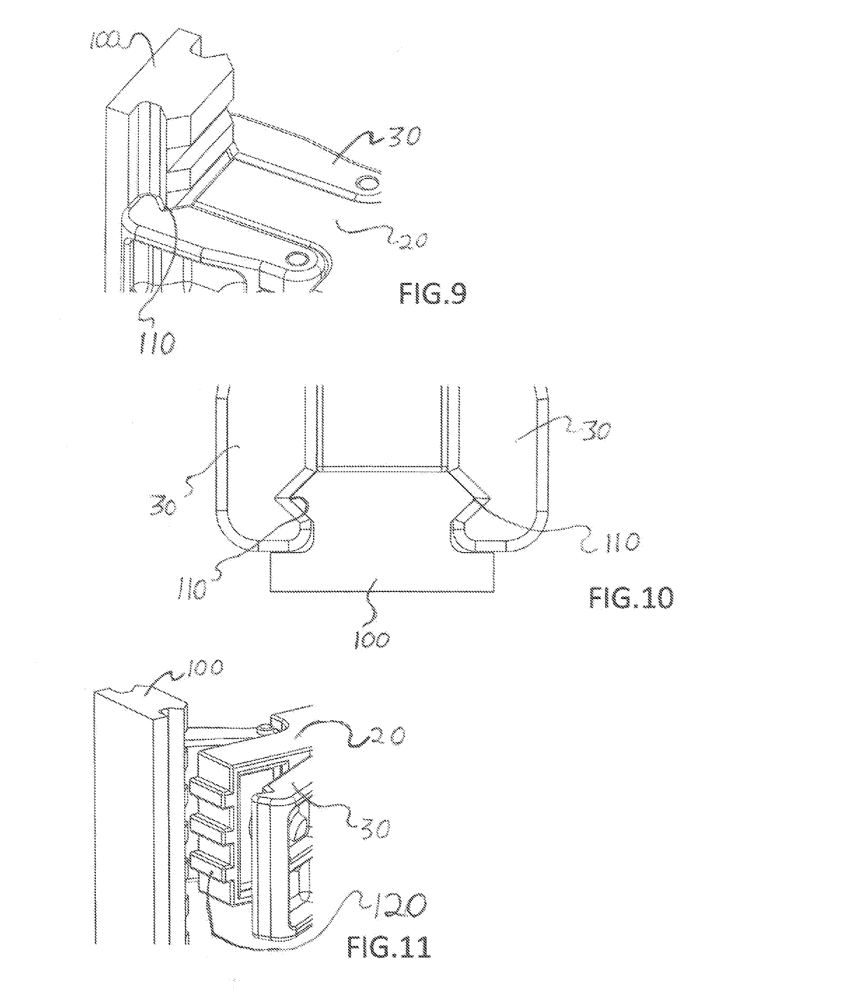

FIG. 8 shows a closed latched position view faking a long line section line A-A of the best mode contemplated by the inventor of the improved Push-Push Latch With Locking Option and Modifiable or fixed Jaw Profile according to the concepts of the present invention.

FIG. 9 shows an isometric top view of the jaw and retained object interaction of the improved Push-Push Latch With Locking Option and Modifiable or fixed Jaw Profile according to the concepts of the present invention.

FIG. 10 shows a top view of the jaw and retained object interaction of the improved Push-Push Latch With Locking Option and Modifiable or fixed Jaw Profile according to the concepts of the present invention.

FIG. 11 shows an isometric top view of the jaw and retained object interaction of the improved Push-Push Latch With Locking Option and Modifiable or fixed Jaw Profile 150 according to the concepts of the present invention.

### DETAILED DESCRIPTION OF THE INVENTION

### 1. Definitions

Push-push and clicker type latches are latches that operate by the user applying a force in one direction toward the latch body to secure the latch. The user then applies a force in the same direction toward the latch body to release the latch.

A self-engaging latch mechanism is a device that automatically or as a derivative result of the user input results in the physical change of the latch engaging it into a feature or surface.

A compressible material is a material that when force is applied it deforms the physical dimension of the material and the material will then return to some ratio of the compressed force dimension and the pre compressed force dimension when the force is released.

A picatinny rail, weaver rail or floating rail structure (e.g., as per standard MIL-STD-1913) is typically used on a firearm weapon for providing a mounting feature for the addition of peripheral items.

A cam is a rotating or sliding piece in a mechanical linkage used especially in transforming rotary motion into linear motion or vice-versa. It is often a cylinder with an irregular shape that strikes a lever at one er more points on its circular path. The cam can be a Hat or curved surface which is making contact with another surface generating desired movement as one or both earn surfaces move.

A bi-pod is a two legged support often used as stabilizing support for a firearm. Likewise a tri-pod is similar in function however containing three legs.

### 2. Best Mode of the Invention

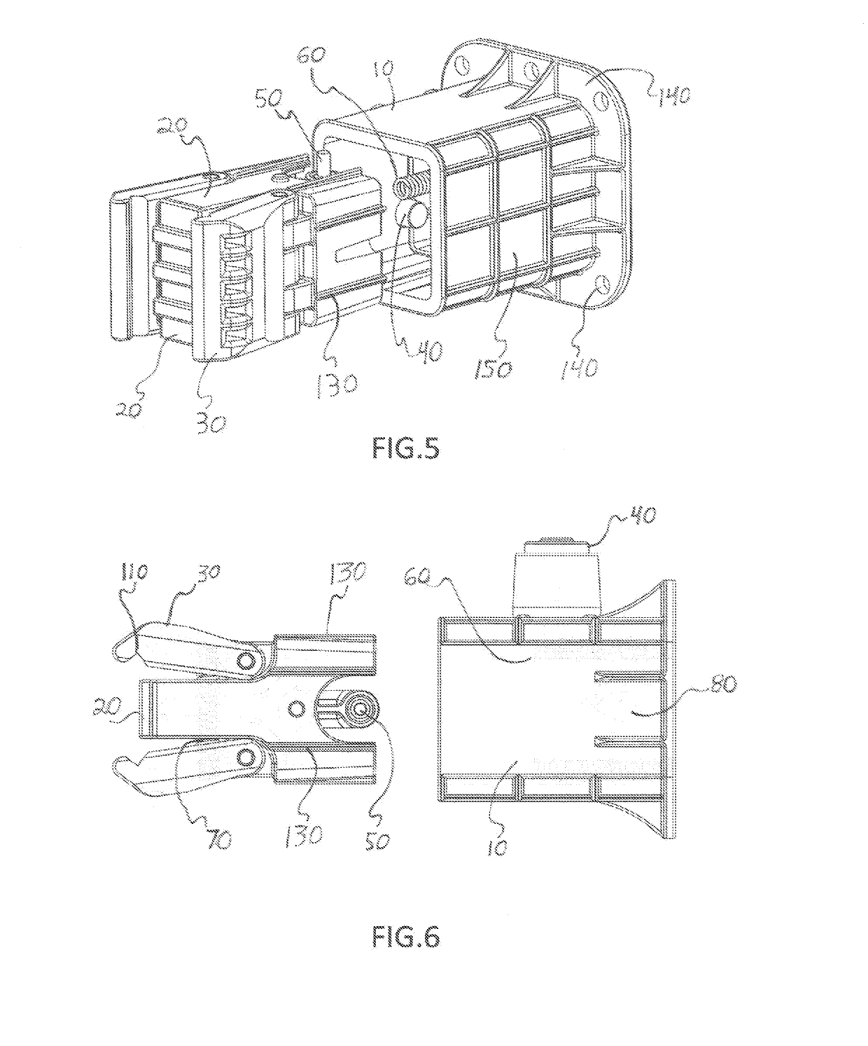

FIG. 5 shows an exploded isometric view and FIG. 7 shows a top sectional view of the best mode contemplated by the inventor of the improved Push-Push Latch With Locking Option and Modifiable or fixed Jaw Profile 150 according to the concepts of the present invention.

### 3. How to Make the Invention

It can be amply seen from the drawings that, the improved Push-Push Latch With Locking Option and Modifiable or fixed Jaw Profile 150 is consisting of an outer housing 10 and an inner housing 20 that slides relative to each, other controlled using a rail and grove 130 mate. The push-push latch would be operated by the user implying a force with one or two hands toward the latch housing sliding the inner housing 20 inside the outer housing 10 resulting in the internal self-engaging latch 50 moving through the heart shaped cam surface 80 positing the internal self-engaging latch 50 into one of the two at rest positions. The inner housing 20 would maintain a force against the outer housing 10 by use of springs 60 to keep the inner self-engaging latch 50 in one of the two at rest positions of the heart shaped cam 80 surface. The heart shaped cam 80 provides control of the inner self-engaging latch mechanism 50 by guiding apposing pins through cannels and along sloping surfaces. The sloping surfaces are terminated by steps which step down to the next segment of the cam surface preventing the internal self-engaging latch opposing pins 50 from movement in the direction in which it had just traveled prior to the step down.

As the action of sliding the inner housing 20 relative to the outer housing 10 takes place opposing jaws 30 contact the outer housing forcing movement in a controlled direction. The jaws 30 contact the outer housing 10 and slide along the housing wherein the opposing jaws 30 move relative to each other by the action 90 of the push-push latch and outer housing 10 interaction 90 in which the motion of the jaws is best described as swinging such as a lever. The Jaws 30 are held opposing each other by use of spring 70 to maintain a force that separates them when they are not forced together by the interaction with the outer housing 10. This separating force spring 70 allows the jaws 30 to release the retained object 100 allowing the user to gain access to the object when desired.

The inner housing 20 and the outer housing 10 are to have the option for locking capability 40 which can be engaged to prevent movement of the inner housing 20 relative to the outer housing 10. This locking mechanism is accurately portrayed by the use of a tubular barrel lock 40 in which the user can depress a pin engaging the inner housing along a feature preventing relative movement. The tubular barrel lock can be released by the user allowing motion of the inner housing 20 and the outer housing 10 to then apply a force toward the push-push latch 150 generating movement of the jaws 30 due to the interaction of the jaws 30 and the outer housing 10 at the interaction point 90 to release the retained object 100.

The Jaws 30 will have a profile that is matched to the retained object 100. An example of this matched profile is the use of opposing triangle shaped groves to engaged a so-called picatinny rail 100 object. As the Jaws 30 are pushed together by the interaction 90 of the outer housing 10 they close around the so-called picatinny rail retaining the rail from unwanted movement. The profile 110 of the jaws 30 may be modified by the manufacture to provide a better fit for additional objects. An example of this jaw profile 110 modification is the use of opposing arcs to secure a tube or round handle. Additional profiles might also be selected for the list: triangle, square, pentagon, hexagon, heptagon, octagon, oval, rectangle, circle, slot, bevel or tear drop.

The Jaw 30 profile 110 might also be manufactured to allow the end user to adjust the profile 110 to better fit a wide variety of objects to foe retained 100. The end user may have the option to install provided inserts into the profile altering the jaw 30 profile 110 and generating the best fit for a desired retained object 100. The jaw 30 profile 110 may also be designed to receive objects such as bolts, nuts, pins or other readily available hardware. This use of hardware could alter the jaw 30 profile 110 to better fit desired retained objects 100. Furthermore said jaws 30 may have a profile 110 consisting of conforming material/action for conforming around objects of which may be selected from the group: rubber, foam, springs, air bags, balloons, fluid envelopes, or material softer than the object, being clamped by the jaw profile.

As can be seen in the drawings the inner housing 20 may contain features for indexing object(s) 120 clamped by the jaws in which the indexing is achieved by one or more of the following mechanisms: grove, slot, pin, dovetail, teardrop, repeating pattern, tooth, knurled surface, bump, adhesive bonding, or gravity. The inner housing 20 would have mating and protruding groves 120 that interlock with a so-called picatinny rail 100 preventing unwanted movement and providing a more secure retention of the grasped object, in this case of retaining a picatinny rail, weaver rail or floating rail system.

The external housing 10 is consisting of features 140 for attachment to additional objects for the purpose of adding additional features to the push-push latch such as selected from the group; optics, bi-pod, tri-pod, locking mount, dove tall, light source, griping function, so-called picatinny rail, weaver rail, floating rail structure, mounting plate, hinge connection, threaded hole, threaded stud, or secondary weapon such as knife, Gun, Taser or pepper Spray. As can clearly be seen in the drawings the outer housing 10 may have a flange with holes providing a location for attaching the push-push latch 150 outer housing 10 to a surface such as a wall. Additional modifications can be made by the manufacture to allow the external housing 10 to have mounting ability for surfaces as described in the list: vehicle dash board, exterior house wall, interior house wall, surface of helicopter, surface of airplane, ceiling, floor, vehicle passenger cab, vehicle cargo cab, law enforcement cage or barrier separating officer from criminals vehicle trunk lid, external vehicle surface, commercial display cabinet, retail display cabinet, motorcycle, backpack, personal protection body armor, submarine interior surface, submarine exterior surface, boat interior surface, beat exterior surface, glass, wood, sheetrock, steel, aluminum, plastic, tile, or cardboard.

These modifications to the external housing 10 may include altering the shape of the outer housing in such a way it better fits the desired mounting surface. Furthermore the outer housing 10 may be manufactured with a universal shape in which the manufacture could produce a custom fit bracket, plate, extension, or other mounting method to enable the push-posh latch 150 outer housing 10 to better be mounted to the desired surface.

### 4. How to Use the Invention

The applications of the improved Push-Push Latch With Locking Option and Modifiable or fixed Jaw Profile 150 are many as can be seen by those skilled in this art. The improved push-push latch 150 can be used to retain objects 100 of a wide verity. These retained objects 100 would have the capability of being locked by the user preventing uncontrolled access and unwanted use. These retained objects can now be secured and displayed in a manner that makes then readily available to the owner and desired users.

The action of the push-push latch 150 by the user allows for one handed operation to retain and release objects 100. These objects such as a firearm may need to be accessed in situations where speed is a factor of life and death. Wherein an officer of the law must retain their firearms preventing unwanted access by general public they must also have immediate access themselves at times of need. Said officer could disengaged the locking feature 40 by use of a key, lever, latch, electronic switch, electronic button or any other manor to release the push-push latch 150 inner housing 20 allowing them to rapidly remove the secured firearm held by the jaws 30. In this scenario the firearm would likely be fitted with a so-called picatinny rail weaver rail or floating rail system in which the jaws 30 would have the corresponding profile 110.

In addition the similar so-called picatinny rail, weaver rail, or floating rail system is found on many firearms owned by the general public as well as the branches of the military. Many members of the general public maintain said firearms for use as personal defense weapons, in order to have immediate access to said firearm when required they often do not secure the firearm inside a locking safe or by any other manor of locking the weapon. The improved Push-Push Latch With Locking Option and Modifiable or fixed Jaw Profile 150 would allow the user to secure their weapon, at a location desired such as behind a door, alongside a bed, inside a closet or any other location they want to mount it. The user could then secure the device when desired by engaging the locking mechanism 40 preventing access to the weapon. Control of weapons in this manor would prevent theft as well as accidental deaths of children caused when they gain access to unsecured firearms.

Furthermore the improved Push-Push Latch With Locking Option and Modifiable or fixed Jaw Profile 150 could be used to retain objects of value or that of witch the user wishes to display. An example of this is the retention of valuable tools such as a chainsaw while camping. The user could mount, the improved Push-Push Latch With Locking Option and Modifiable or fixed Jaw Profile 150 outside their recreational vehicle providing a location to securely raisin their chainsaw when not in use in order to keep the storage available in the vehicle free for alternate use as well as remove the chainsaw from the vehicle preventing the spread of fuel fumes. The user could also display expensive jewelry by the use of the push-push latch 150 allowing them to secure it preventing theft.

What is claimed is:

1. A lockable push-push latch, comprising: internal two position self-engaging latch mechanism; heart shaped cam surface controlling said self-engaging latch mechanism generating two positions by which the self-engaging latch mechanism is internally at rest; lockable feature by which to prevent motion between internal self-engaging position one and self-engaging position two; said lock comprising a mechanism by which the user can engage preventing the push-push latch from movement between internal self-engaging mechanism position one and internal self-engaging position two.

2. A lockable push-push latch according to claim 1, wherein said push-push latch is operated by the user or a generated force to push the latch for operation.

3. A lockable push-push latch according to claim 1, wherein said internal two position self-engaging latch mechanism is comprised of opposing pins maintain a force in opposite directions with the use of one or more force generating mechanisms selected from the group consisting of: spring, hydraulic pressure, air pressure, gravity or compressible material.

4. A lockable push-push latch according to claim 1, wherein a heart shaped cam controls the movement of said internal self-engaging latch with the use of ramping surfaces and steps between distinct cam surfaces in controlling the latching pin directions and provide distinct rest positions for said latching pins at two locations.

5. A lockable push-push latch according to claim 1, wherein said lockable feature prevents the posh-push latch movement preventing the internal self-engaging pins movement from rest position one to rest position two, said lockable feature achieved by use of one or more selected from the group consisting of: tubular barrel push lock, swing latch lock, opposing electric force, opposing magnetic force, sprung pin, sprung bar, twist to extend lock, bolt, pin, wire, lever or plate.

6. An improved posh-posh latch, comprising: opposing jaws operated by push-push action and outer housing interaction; universal jaw profile for engagement of objects: jaw profile for engagement to so-called picatinny rail, weaver rail or floating rail structure (e.g., as per standard MIL-STD-1913); modifiable jaw profile for engagement to non-specific objects; jaw profile consisting of conforming material for conforming around objects; mechanism for generating force for automatic jaw separation at desired position.

7. An improved push-push latch according to claim 6; wherein opposing jaws move relative to each other by the action of the push-push latch and outer housing interaction in which the motion of the jaws is described by one or more of the motions from the group: cam, swing, hinge, slide, push or pull.

8. An improved push-push latch according to claim 6; wherein the said jaws have a universal jaw profile for engaging objects as selected from the group: polygon, triangle, square, pentagon, hexagon, heptagon, octagon, oval, rectangle, circle, slot, bevel or tear drop.

9. An improved push-push latch according to claim 6; wherein said jaws have a profile for engagement to so-called picatinny rail, weaver rail or floating rail structure (e.g., as per standard MIL-STD-1913), as used on weapons found in military use, civilian use, law enforcement, and use on non-weapon applications.

10. An improved push-push latch according to claim 6; wherein said jaws have a modifiable profile the end user or manufacture can use to change the profile with the use of inserts of which may poses unique end specific profiles or universal profiles.

11. An improved push-push latch according to claim 6; wherein said jaws have a profile consisting of conforming material/action for conforming around objects of which may be selected from the group: rubber, foam, springs, air bags, balloons, fluid envelopes, or material softer than the object being clamped by the jaw profile.

12. An improved push-push latch according to claim 6; wherein said jaws have a mechanism for generating force for automatic jaw separation at a desired position achieved to release retained object by one or more selected from the group consisting of; spring, opposing electric force, opposing magnetic force, sprung pin, sprung bar, wire, lever, hydraulic, pneumatic or stored energy force.

13. An improved push-push latch, comprising: internal housing mechanism that slides relative to an external housing mechanism in a controlled direction; internal housing contains features for indexing object(s) clamped by jaws; internal slide has force generated between it and the external housing in one direction; external housing is consisting of features for attachment to additional objects; external housing is consisting of adaptable and interchangeable features for mounting to surfaces; internal housing and external housing have a operable method of one or two hands for engaging and releasing a retained object.

14. An improved push-push latch according to claim 13; wherein the internal housing mechanism slides relative to an external housing mechanism in a controlled direction by the use of one of the mechanisms selected from the group: rails, tube, collar, guides, groves, bushing, dove tail, tapper or pins.

15. An improved push-push latch according to claim 13; wherein the internal housing contains features for indexing object(s) clamped by jaws as described in claim 6 in which the indexing is achieved by one or more of the following mechanisms; grove, slot, pin, dove tail, tear drop, repeating pattern, tooth, knurled surface, bump, adhesive bonding, or gravity.

16. An improved push-posh latch according to claim 13; wherein the internal slide has force generated between it and the external housing in one direction achieved by one or more from the following group: spring, opposing electric force, opposing magnetic force, sprung pin, sprung bar, wire, lever, hydraulic, compressible material, pneumatic or gravity.

17. An improved push-push latch according to claim 13; wherein the external housing is consisting of features for attachment to additional objects for the purpose of adding additional features to the push-push latch such as selected from the group; optics, bi-pod, tri-pod, locking mount, dove tail, light source, griping function, so-called picatinny rail, weaver rail, floating rail structure, mounting plate, hinge connection, threaded hole, threaded stud, or secondary weapon such as knife, Gun, Taser or pepper Spray.

18. An improved push-push latch according to claim 13; wherein the external housing is consisting of adaptable and interchangeable features for mounting to surfaces as described in the list: vehicle dash board, exterior house wall, interior house wall, surface of helicopter, surface of airplane, ceiling, floor, vehicle passenger cab, vehicle cargo cab, law enforcement cage or barrier separating officer from criminal, vehicle trunk lid, external vehicle surface, commercial display cabinet, retail display cabinet, motorcycle, backpack, personal protection body armor, submarine interior surface, submarine exterior surface, boat interior surface, boat exterior surface, glass, wood, sheetrock, steel, aluminum, plastic, tile, or cardboard.

19. An improved push-push latch according to claim 13; wherein the internal housing and external housing have a operable method of one or two hands for engaging and releasing a retained object.
